(19) United States
(12) Patent Application Publication
(10) Pub. No.: US 2005/0082965 A1
(43) Pub. Date: Apr. 21, 2005

(54) LED with good heat-dissipating capability

(76) Inventors: Chiao-Chiang Huang, Taipei (TW); Yuan-Tai Huang, Taipei (TW)

Correspondence Address: DELLETT AND WALTERS, P. O. BOX 2786, PORTLAND, OR, 97208-2786, US

(21) Appl. No.: 10/687,435

(22) Filed: Oct. 16, 2003

(51) Int. Cl. H01J 1/62; H01J 63/04

(52) U.S. Cl. 313/498

(57) ABSTRACT

A light emitting diode (LED) has a leadframe, at least one LED chip and an encapsulant. The leadframe has a first and a second pin each having an upper sealed portion and a bottom exposed portion. The upper sealed portion on which the LED chip is mounted is covered by the encapsulant. The bottom exposed portion is composed of a neck and a longitudinal conductor. The neck is larger than the longitudinal conductor to increase the surface area and the capability to dissipate heat. The neck may further have a transverse fin to increase the surface area and heat dissipation. Therefore, the present invention has a good heat-dissipating capability.

### BACKGROUND OF THE INVENTION

1. Field of the Invention

The present invention relates to an LED, and more specifically to an LED that has a good heat-dissipating capability.

2. Description of Related Art

With reference to FIG. 6, a first conventional light emitting diode (LED) has a leadframe (not numbered), an LED chip (51) and a transparent encapsulant (52). The leadframe has a first conducting pin (501), a second conducting pin (502) and an upper portion (not numbered). The first and second conducting pins (501, 502) respectively have bottom portions (not numbered) and tops (not numbered). The LED chip (51) is mounted on the top of the first conducting pin (501) and is wire bonded to the other pin (502). The transparent encapsulant (52) covers and seals the LED chip (51) and the upper portion of the leadframe. The bottom portions of the two pins (501, 502) are plugged into a printed circuit board (not shown) and then soldered on the PCB.

When the LED operates, the LED chip produces heat. Because the LED chip is covered and sealed in the transparent encapsulant, dissipating the heat to the air through the encapsulant is difficult. Therefore, generated heat is conducted through the leadframe to the lower portions of the first and second conducting pins (501, 502) and is dissipated to the air.

The foregoing LED structure is not suitable for use in a circuit with large current because the large current input to the LED chip and the LED chip will produce large quantities of heat and burn out the LED.

With reference to FIG. 7, a second conventional LED has better heat dissipating capability than the first conventional LED. Consequently, a larger current can be input to the second conventional LED so the light emitted from the LED will be brighter. The second conventional LED also has a leadframe (60), an LED chip (65), an encapsulant (66) and four pins (61 to 64). Heat generated by the LED chip and the current when the second conventional LED operates is also conducted to the four pins (61 to 64) for dissipation to the air because of the difficulty of conducting the heat through the encapsulant (66). However, because the second conventional LED has four pins (61 to 64) instead of two and the heat conducting area is larger, heat generated by the LED chip (65) and the current can be dissipated more quickly. However, this second LED is larger than the first conventional LED.

With reference to FIG. 8, a third conventional LED is a surface mounted device (SMD) and also includes a leadframe (70), an LED chip (77) and a transparent encapsulant (78). The leadframe (70) has two U-shaped leads (not numbered) respectively having an L-shaped leg (not numbered) and three pins (71 to 73 and 74 to 76). The two U-shaped leads connect the LED to a PCB. Since the leads are composed of three pins (71 to 73 and 74 to 76), the leadframe (70) has a larger surface area and dissipates heat more quickly than the first or second conventional LED. Therefore, the third conventional LED is suitable for use in circuits with a larger current and is brighter. However, the third conventional LED is larger than the second conventional LED.

The present invention provides a small-size LED having a good heat-dissipating capability to mitigate or obviate the aforementioned problems.

### SUMMARY OF THE INVENTION

An objective of the present invention is to provide a small-size LED having a good heat-dissipating capability and suitable to use in a circuit with a large current.

Another objective of the present invention is to provide an LED that can be easily formed as a surface mounted device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an LED in accordance with the present invention;

FIG. 2 is a side plan view of the LED in FIG. 1;

FIG. 3 is a side plan view of a second embodiment of an LED in accordance with the present invention;

FIG. 4 is a perspective view of a third embodiment of an LED in accordance with the present invention;

FIG. 5 is a side plan view of the LED in FIG. 4;

FIG. 6 is a perspective view of a first conventional LED in accordance with the prior art;

FIG. 7 is a perspective view of a second conventional LED in accordance with the prior art; and

FIG. 8 is a perspective view of a third conventional LED in accordance with the prior art.

### DETAILED DESCRIPTION OF THE PREFERRED EMBODIMENT

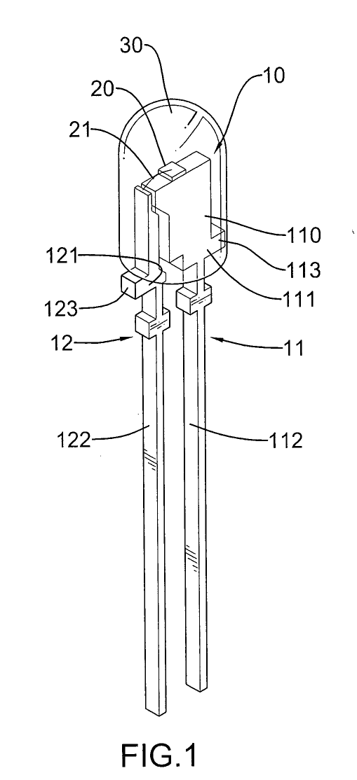

With reference to FIG. 1, a first embodiment of an LED in accordance with the present invention includes a leadframe (10), at least one LED chip (20) and a transparent encapsulant (30).

The leadframe (10) has a first pin (11) and a second pin (12). The first and second pins (11, 12) respectively have an upper sealed portion (110, 120) and a bottom exposed portion (not numbered). The upper sealed portions (110, 120) of the first and second pins (11, 12) are covered by the transparent encapsulant (30), and the bottom exposed portions of the first and second pins (11, 12) are bare.

The upper sealed portion (110) of the first pin (11) has a die pad (not numbered) on which the LED chip (20) is mounted. The bottom exposed portion of the first pin (11) extends downward from the die pad and is composed of a neck (111) and a longitudinal conductor (112). The neck (111) has a surface area, which is larger than the conductor (112) and further expends to form a right transverse fin (113).

The upper sealed portion (120) of the second pin (12) is bonded to the LED chip (20) on the die pad on the first pin (11) with a wire (21). The bottom exposed portion of the second pin (12) extends downward from the upper portion (120) and composed of a neck (121) and a longitudinal conductor (122). The neck (121) is larger than the longitudinal conductor (122) and further expends to form a left transverse fin (121).

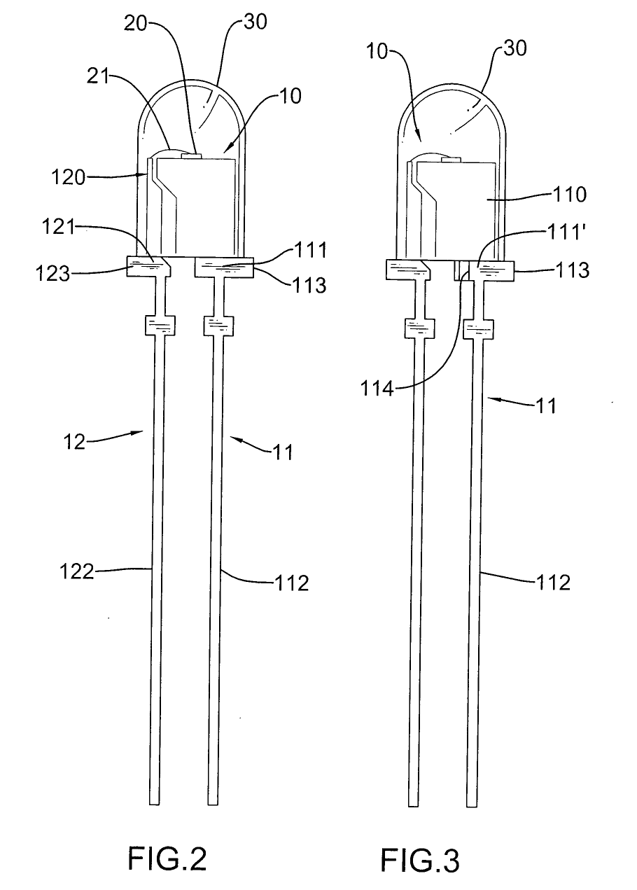

The transverse fins (113, 123) respectively have lengths based on the normal rated current of the LED chip (20). With reference to FIG. 2, the transparent encapsulant (30) covers and seals the LED chip (20), the wire (21) and the upper sealed portions (10, 120) of the first and second pins (11, 12).

With reference to FIG. 3, a second embodiment of an LED in accordance with the present invention is similar to the first embodiment and further includes at least one slot (114). The slot (114) is defined in the neck (111′) to increase the surface area of the neck (111′). Consequently, the second embodiment of the LED has a larger heat-dissipating area to dissipate heat in the encapsulant (30) to the air more quickly.

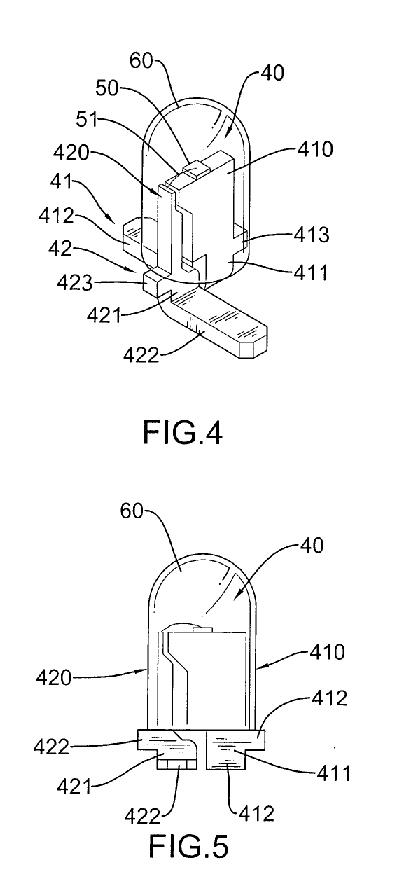

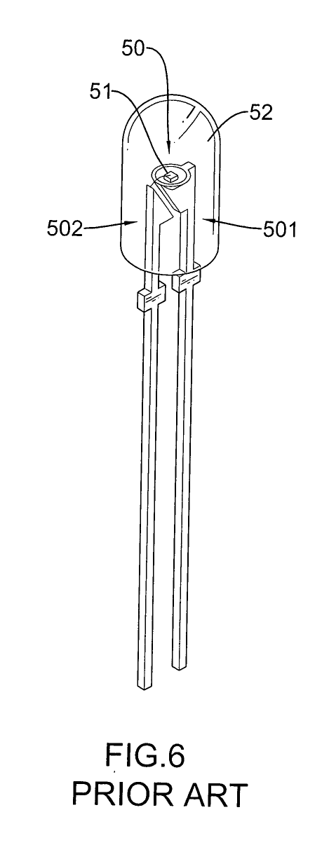

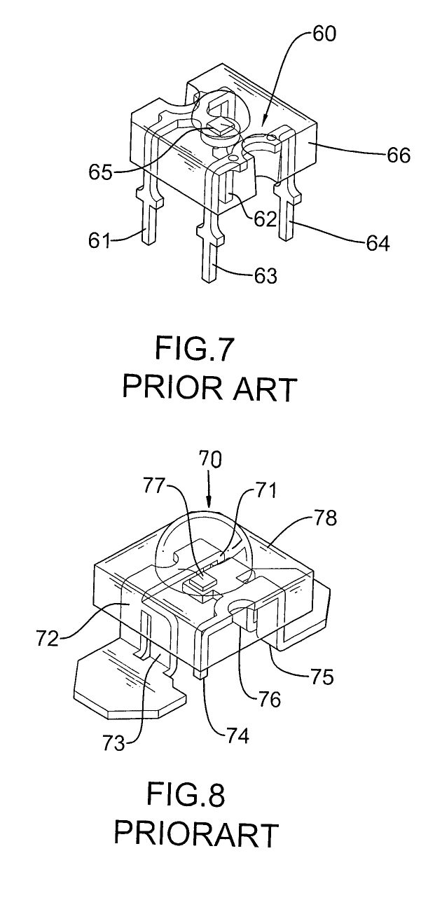

With reference to FIGS. 4 and 5, a third embodiment of an LED in accordance with the present invention is formed as a surface mounted device (SMD). The LED includes a leadframe (40), at least one LED chip (50) and a transparent encapsulant (60).

The leadframe (50) has a first pin (41) and a second pin (42). The first and second pins (41, 42) respectively have an upper sealed portion (410, 420) and a bottom exposed portion (not numbered). The upper sealed portions (410, 420) are covered by the transparent encapsulant (60) and the bottom exposed portions are bare.

The upper sealed portion (410) of the first pin (41) has a die pad (not numbered) on which the LED chip (50) is mounted.

The bottom exposed portion of the first pin (41) is composed of a neck (411) and a lateral conductor (412). The neck (41 1) has a surface area, which is equal to the conductor's (412) and further expends to form a right transverse fin (413). The lateral conductor (412) extends laterally from the neck (411) so the bottom exposed portion is formed as L-shape. The LED chip (50) is bonded to the die pad on the upper sealed portion (420) of the second pin (42) with a wire (51).

The bottom exposed portion of the second pin (42) is composed of a neck (421) and a horizontal conductor (422). The neck (421) has a surface area, which is equal to the conductor's (422) and further expends to form a left transverse fin (423). The horizontal conductor (422) extends horizontally from the neck (421) so the bottom exposed portion is formed as L-shape. The lateral conductors (412, 422) of the bottom exposed portions of the first and second pins (41, 42) are soldered to a print circuit board (PCB).

The bottom exposed portions of the first and second pins are larger than dual pin conventional LEDs. Further, each neck can be configured with a transverse fin or a slot defined in the base to increase the surface area so the present invention has a better heat dissipation capability. Consequently, the LED is suitable for use in a circuit with a large current and is brighter.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A light emitting diode (LED) having a good heat-dissipating capability, comprising
a leadframe having
a first pin with an upper sealed portion and a bottom exposed portion composed of a neck and a conductor extending from the neck for connecting to a printed circuit board; and
a second pin having an upper sealed portion and a bottom exposed portion composed of a neck and a conductor extending from the neck for connecting to the printed circuit board;
an LED chip mounted on the upper sealed portion of the first pin and wire bonded to the upper portion of the second pin; and
an encapsulant covering and sealing the upper sealed portion of the first and second pin and the LED chip.

2. The LED as claimed in claim 1, further comprising a transverse fin expending from the neck of the first fin.

3. The LED as claimed in claim 1, further comprising a transverse fin expending from the neck of the second fin.

4. The LED as claimed in claim 2, further comprising a transverse fin expending from the neck of the second fin.

5. The LED as claimed in claim 2, wherein each conductor extends longitudinally from the neck to form a longitudinal conductor and each neck is larger than the conductor in a surface area.

6. The LED as claimed in claim 3, wherein each conductor extends longitudinally from the neck to form a longitudinal conductor and each neck is larger than the conductor in a surface area.

7. The LED as claimed in claim 4, wherein each conductor extends longitudinally from the neck to form a longitudinal conductor and each neck is larger than the conductor in a surface area.

8. The LED as claimed in claim 2, wherein
each conductor extends laterally from the neck to form a lateral conductor and has a surface area; and
each neck has a surface area equal to the surface area of the conductor.

9. The LED as claimed in claim 3, wherein
each conductor extends laterally from the neck to form a lateral conductor and has a surface area; and
each neck has a surface area equal to the surface area of the conductor.

10. The LED as claimed in claim 4, wherein
each conductor extends laterally from the neck to form a lateral conductor and has a surface area; and
each neck has a surface area equal to the surface area of the conductor.

11. The LED as claimed in claim 1, further comprising at least one slot in the neck of the first pin.

12. The LED as claimed in claim 2, further comprising at least one slot in the neck of the first pin.

13. The LED as claimed in claim 3, further comprising at least one slot in the neck of the first pin.
